(19) United States
(12) Patent Application Publication
(10) Pub. No.: US 2026/0331676 A1
(43) Pub. Date: Oct. 22, 2026

(54) BATTERY PACK STRUCTURE

(71) Applicant: TOYOTA JIDOSHA KABUSHIKI KAISHA, Toyota-shi (JP)

(72) Inventor: Yugo MOCHIZUKI, Nisshin-shi (JP)

(73) Assignee: TOYOTA JIDOSHA KABUSHIKI KAISHA, Toyota-shi (JP)

(21) Appl. No.: 19/468,315

(22) Filed: Feb. 3, 2026

(30) Foreign Application Priority Data
Apr. 3, 2025 (JP) 2025-062101

(51) Int. Cl. H01M 50/262; H01M 50/204; H01M 50/242; H01M 50/249

(52) U.S. Cl. CPC H01M 50/262; H01M 50/204; H01M 50/242; H01M 50/249; H01M 2220/20

(57) ABSTRACT

A battery pack structure includes a battery module, including a plurality of battery cells disposed arrayed in parallel in a predetermined direction, and an end plate disposed on an outer side in an array direction of the battery cells, a lower case that accommodates a lower portion of the battery module, and a module bracket that fixes the end plate to the lower case such that a gap is created between the end plate and an inner wall face of the lower case, and that also includes a bending point that bends toward the end plate side at a portion facing the end plate, and further extends from the bending point along the end plate to fashion an abutting face that faces the end plate.

### CROSS-REFERENCE TO RELATED APPLICATION

This application claims priority to Japanese Patent Application No. 2025-062101 filed on Apr. 3, 2025. The disclosure of the above-identified application, including the specification, drawings, and claims, is incorporated by reference herein in its entirety.

### BACKGROUND

### 1. Technical Field

The present disclosure relates to a battery pack structure.

### 2. Description of Related Art

Japanese Unexamined Patent Application Publication No. 2018-073542 (JP 2018-073542 A) below discloses an example of a battery module fixing structure.

To briefly describe this, forms of end plates and side plates of this battery module fixing structure are devised so as to suppress load fluctuations caused by temperature change in cells, or expansion and contraction due to aging thereof, from being conveyed to module fixing points.

### SUMMARY

However, the technology described in JP 2018-073542 A leaves room for improvement in the following respects. That is to say, in order to simplify an energy absorption mechanism that is to be used in an event of a collision, it is necessary to utilize a load in a stacking direction of a module, but connection between a lower case and the module has low rigidity in a case in which this structure is employed. In other words, the connection from a module attaching point to the cells is low in rigidity. This makes it difficult to convey an external collision load to the module.

In light of the above, an object of the present disclosure is to provide a battery pack structure that can connect a battery module to a lower case with low rigidity when a battery is in use, and that can connect the battery module to the lower case with high rigidity in the event of a collision.

A battery pack structure according to a first aspect of the present disclosure includes a battery module, including a plurality of battery cells disposed arrayed in parallel in a predetermined direction, and an end plate disposed on an outer side in an array direction of the battery cells, a lower case that accommodates a lower portion of the battery module, and a module bracket that fixes the end plate to the lower case such that a gap is created between the end plate and an inner wall face of the lower case, and that also includes a bending point that bends toward the end plate side at a portion facing the end plate, and further extends from the bending point along the end plate to fashion an abutting face that faces the end plate.

According to the first aspect of the present disclosure, the end plate of the battery module is fixed to the lower case via the module bracket, and the bending point of bending toward the end plate side is provided at the portion of the module bracket facing the end plate. Accordingly, during normal use of the battery pack, load fluctuations caused by expansion and contraction of the battery cells are absorbed by displacement of the bending point, and are conveyed to a fixing point of the module bracket and the lower case less readily. That is to say, rigidity of a fixing structure for the battery module is reduced.

On the other hand, the abutting face that extends from the bending point along the end plate, and faces the end plate, is formed in the portion of the module bracket that faces the end plate. Accordingly, when a collision load is input from the module bracket side to the end plate side in the event of a collision, the abutting face abuts the end plate first, thereby connecting the battery module and the lower case with high rigidity via the module bracket, and quickly generating a reactive force with respect to the collision load. That is to say, in the event of a collision, a state in which the battery module and the lower case are connected with high rigidity can be reproduced.

With the battery pack structure according to a second aspect of the present disclosure, in the disclosure according to the first aspect, the end plate includes a projecting portion that protrudes toward the lower case side at a position facing the lower case.

According to the second aspect of the present disclosure, the end plate is provided with the projecting portion that protrudes toward the lower case side at the position facing the lower case, and accordingly the lower case deforms and strikes the projecting portion in the event of a collision. This enables a reactive force to be generated from the end plate toward the lower case side via the projecting portion. As a result, reactive force can be quickly generated not only at the abutting face but also at the projecting portion.

With the battery pack structure according to a third aspect of the present disclosure, in the disclosure according to the second aspect, a protruding portion that protrudes toward the end plate side is provided at a position on the lower case facing the projecting portion.

According to the third aspect of the present disclosure, the protruding portion that protrudes toward the end plate side is provided at the position on the lower case facing the projecting portion provided on the end plate, and accordingly a distance between the protruding portion and the projecting portion is shorter than the distance at places where the protruding portion is not present. Accordingly, in the event of a collision, the protruding portion of the lower case and the projecting portion of the end plate quickly abut each other, thereby generating reactive force. Thus, a collision reactive force can be quickly generated outside the battery pack in the event of a collision, and when an energy absorbing member or the like is disposed outside the lower case, for example, the reactive force can be quickly made to act on the energy absorbing member to cause plastic deformation thereof.

With the battery pack structure according to a fourth aspect of the present disclosure, in the disclosure according to the third aspect, a reinforcing rib that connects the projecting portion to a fixing portion fixing the end plate and the lower case to each other, is provided on a face of the end plate facing the lower case.

According to the fourth aspect of the present disclosure, the reinforcing rib, connecting the fixed portion and the projecting portion, is provided on the face of the end plate facing the lower case, such that the collision load input in the event of a collision is distributed across the entire end plate via the reinforcing rib.

As described above, the battery pack structure according to the first aspect of the present disclosure has an excellent effect of being able to connect the battery module to the lower case with low rigidity when the battery is in use, and to connect the battery module to the lower case with high rigidity in the event of a collision.

The battery pack structure according to the second aspect of the present disclosure has an excellent effect of increasing the number of portions where reactive force is generated in the event of a collision, thereby enhancing high rigidity characteristics required in the event of a collision.

The battery pack structure according to the third aspect of the present disclosure has an excellent effect of improving energy absorption performance in the event of a collision.

The battery pack structure according to the fourth aspect of the present disclosure has an excellent effect of being able to quickly generate a collision reactive force, while suppressing input of the collision load to the battery cell side.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic longitudinal sectional view illustrating an overall structure of a battery pack structure according to an embodiment, taken along a vehicle width direction;

FIG. 2 is an enlarged cross-sectional view of a principal portion of the battery pack structure illustrated in FIG. 1;

FIG. 3 is an enlarged frontal view of an end plate illustrated in FIG. 1; and

FIG. 4 is a cross-sectional view illustrating a principal portion structure of the battery pack structure illustrated in FIG. 2, taken along line 4-4.

### DETAILED DESCRIPTION OF EMBODIMENTS

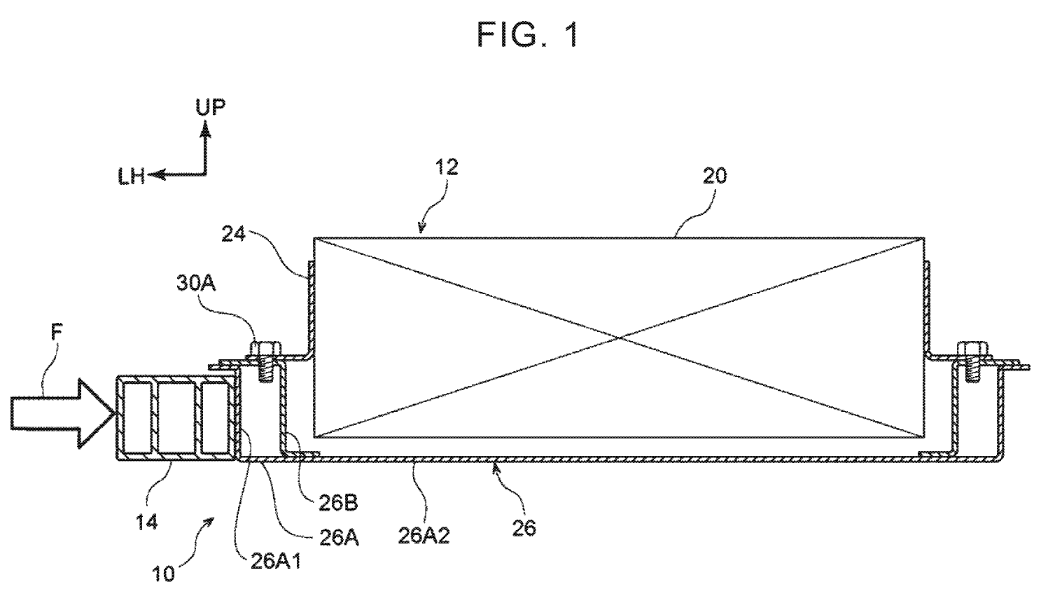

A battery pack structure according to an embodiment will be described below with reference to FIGS. 1 to 4. Note that in these drawings, arrow UP indicates an upward side of a vehicle, arrow LH indicates a leftward side in a vehicle width direction, and arrow FR indicates a forward side of the vehicle.

### Overall Structure of Battery Pack Structure

FIG. 1 is a schematic longitudinal-sectional view illustrating an overall battery pack structure according to the present embodiment, taken along the vehicle width direction. As illustrated in this drawing, a battery pack 12 having a substantially rectangular shape in plan view is arranged on a lower side of a cabin of a vehicle 10 (vehicle lower side of vehicle body floor). Further, an energy absorbing member 14 that is elongated in form, with a longitudinal direction thereof extending in a vehicle front-rear direction is arranged on an outer side of the battery pack 12 in the vehicle width direction. Note that FIG. 1 illustrates only the energy absorbing member 14 on a left side of the battery pack 12 in the vehicle width direction, a similar energy absorbing member is also arranged on a right side of the battery pack 12 in the vehicle width direction. The energy absorbing member 14 has a rectangular closed cross-section and has two partition walls formed therein. As an example, the energy absorbing member 14 is made of an extruded material.

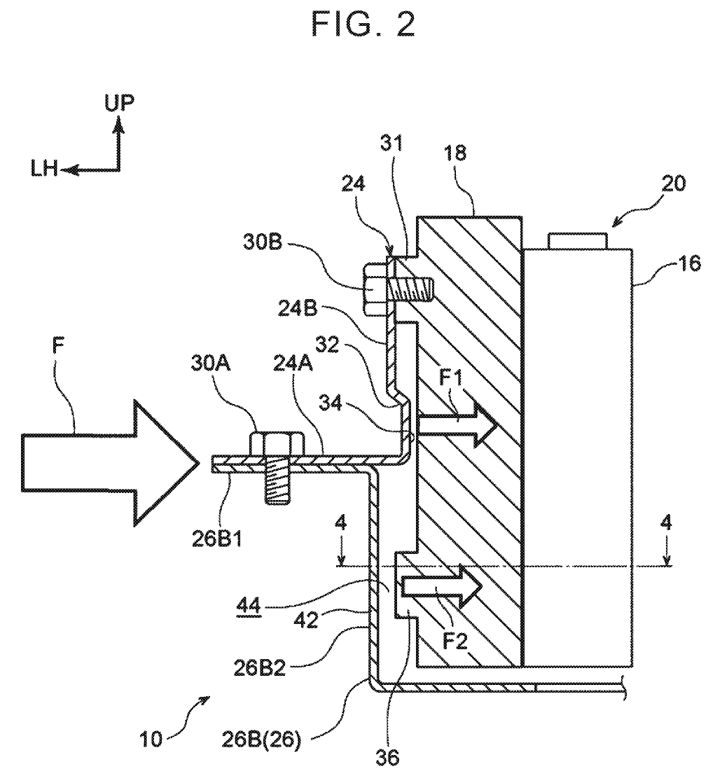

As illustrated in FIGS. 1 and 2, the battery pack 12 includes a plurality of battery modules 20, each of which includes a plurality of battery cells 16 stacked in a predetermined direction as a stacking direction, and end plates 18 disposed at end portions of the stacking direction.

The above-described battery modules 20 are accommodated in a case 22. The case 22 is configured including a lower case 26 having a hat-shaped cross-section and making up a lower part of the case 22, and an upper case (omitted from illustration) fit to the lower case 26 and making up an upper part of the case 22.

Further, the lower case 26 is configured including a main body portion 26A having a hat-shaped cross-section, and a reinforcement 26B having an substantially Z-shaped cross-section that forms a rectangular closed cross-sectional structure together with a side wall portion 26A1 situated on an outer side of this main body portion 26A in the vehicle width direction, and a bottom wall portion 26A2.

### Principal Portion Structure of Battery Pack Structure

The above-described battery module 20 is attached to the reinforcement 26B of the lower case 26 via a module bracket 24. Specifically, as illustrated in FIG. 2, the module bracket 24 is formed in an L-shape as viewed in the vehicle front-rear direction, and is made up of a lateral wall portion 24A extending along the vehicle width direction, and an upright wall portion 24B bending from an inner end portion of the lateral wall portion 24A toward the vehicle upward side and extending in the vehicle up-down direction. The lateral wall portion 24A is fastened to a horizontal flange portion 26B1 of the reinforcement 26B by a first bolt 30A and a weld nut that is omitted from illustration. Also, the upright wall portion 24B is fastened to a boss 31 formed on a side face of the end plate 18 by a second bolt 30B.

Now, the upright wall portion 24B of the above-described module bracket 24 is first bent diagonally downward toward the end plate 18 side at a predetermined position at a lower part thereof, and then bent so as to be pendent along the side face of the end plate 18 toward the bottom wall portion 26A2 side of the lower case 26. Hereinafter, an end point of the obliquely downward bend will be referred to as "bending point 32", and the inner wall face bent so as to be pendent from this bending point 32 will be referred to as "abutting face 34". The abutting face 34 is disposed facing a middle portion of the side face of the end plate 18, across a small gap therebetween.

Also, as illustrated in FIGS. 1 to 3, a plurality of projecting portions 36, each of which is cylindrical in shape and integrally formed at a lower part of the side face of the end plate 18, on the outer side in the vehicle width direction, at predetermined intervals in the vehicle front-rear direction. The projecting portions 36 preferably are solid, but may be hollow. Also, the shape of the projecting portions 36 is not necessarily limited to a cylindrical shape, and may be a prismatic shape instead. In the present embodiment, the projecting portions 36 are formed at three places, which are the front and rear end sides and the middle portion of the end plate 18. The projection height of the projecting portions 36 is set to be the same as that of the boss 31, and the size thereof is also set to be approximately the same.

Also, the reinforcing ribs 38 that are substantially lattice-shaped and that extend in the upright direction and the lateral direction, are integrally formed on the side face of the end plate 18 on the outer side in the vehicle width direction. The three projecting portions 36 are connected to one another by the reinforcing ribs 38. Also, four bosses 31 are also connected to one another by the reinforcing ribs 38. That is to say, the multiple projecting portions 36 and a plurality of the bosses 31 are interconnected to one another by the reinforcing ribs 38.

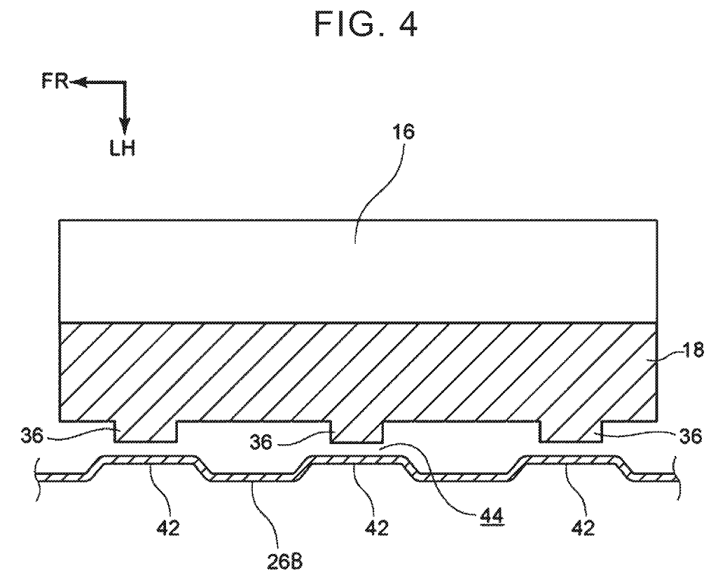

As illustrated in FIG. 4, an upright wall 26B2 of the reinforcement 26B in the lower case 26 described above is formed having an uneven form in a plan cross-sectional view. Thus, protruding portions 42 are disposed on the upright wall 26B2 at positions facing the projecting portions 36 in the vehicle width direction, in close proximity to each other. Slight gaps 44 are provided between apices of the protruding portions 42 and end faces of the projecting portions 36. Note, however, that the gaps 44 are set to be wider than the gap between the abutting face 34 and the end plate 18.

### Effects and Advantages

Next, the effects and advantages of the battery pack structure according to the present embodiment will be described.

According to the present embodiment, the end plate 18 of the battery module 20 is fixed to the lower case 26 via the module bracket 24, and the bending point 32 of bending toward the end plate 18 side is provided at the portion of this module bracket 24 facing the end plate 18.

Accordingly, during normal use of the battery pack 12, load fluctuations caused by expansion and contraction of the battery cells 16 are absorbed by displacement of the bending point 32, and are conveyed to the first bolt 30A between the module bracket 24 and the lower case 26 less readily. That is to say, the rigidity of the fixing structure for the battery module 20 is reduced.

On the other hand, the abutting face 34 that extends from the bending point 32 along the end plate 18, and faces the end plate 18, is formed in the portion of the module bracket 24 that faces the end plate 18.

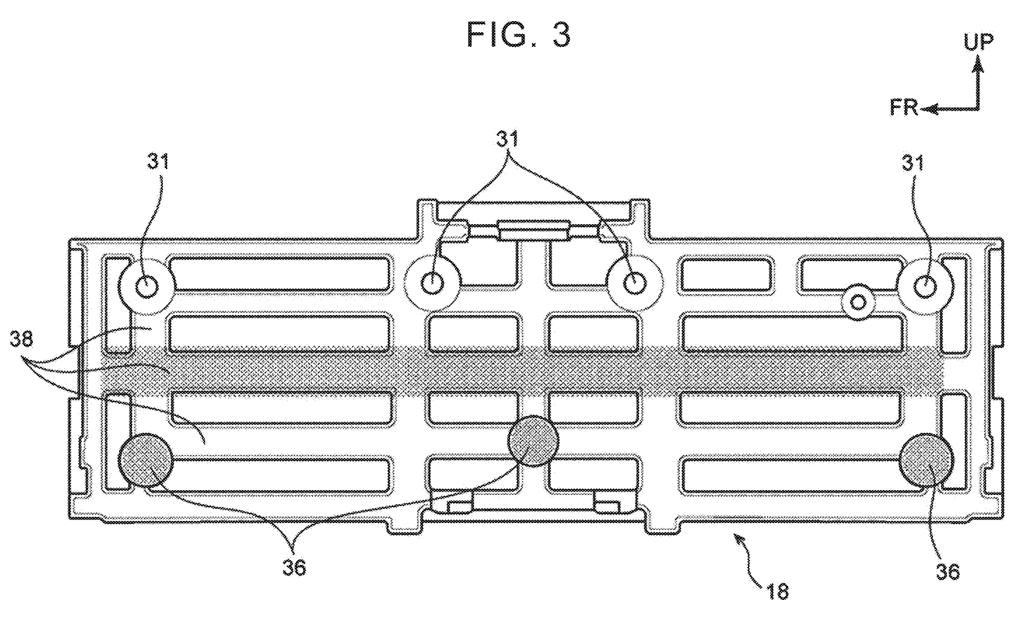

Accordingly, when a collision load F is input from the module bracket 24 side to the end plate 18 side in the event of a collision, the abutting face 34 first comes into contact with the end plate 18 (reinforcing ribs 38 indicated by dotted shading in FIG. 3 ), thereby connecting the battery module 20 and the lower case 26 with high rigidity via the module bracket 24, and quickly generating a reactive force with respect to collision load F1. That is to say, in the event of a collision, a state in which the battery module 20 and the lower case 26 are connected with high rigidity can be reproduced.

As described above, the battery pack structure according to the present embodiment can connect the battery module 20 to the lower case 26 with low rigidity when the battery is in use, and can connect the battery module 20 to the lower case 26 with high rigidity in the event of a collision.

In addition, according to the present embodiment, the projecting portions 36 that protrude toward the lower case 26 side are provided at positions on the end plate 18 facing the lower case 26, such that, in the event of a collision, the lower case 26 deforms and strikes the projecting portions 36, and collision load F2 is input. This enables a reactive force to be generated from the end plate 18 toward the lower case 26 side via the projecting portions 36. As a result, reactive force can be quickly generated not only at the abutting face 34 but also at the projecting portions 36. As a result, the battery pack structure according to the present embodiment increases the number of portions where reactive force is generated in the event of a collision, and can enhance the high rigidity characteristics required in the event of a collision.

Furthermore, in the present embodiment, the protruding portions 42 that protrude toward the end plate 18 side are provided at positions on the lower case 26 facing the projecting portions 36 provided on the end plate 18, and accordingly the distance between the protruding portions 42 and the projecting portions 36 is shorter than the distance at places where the protruding portions 42 are not present.

Accordingly, in the event of a collision, the protruding portions 42 of the lower case 26 and the projecting portions 36 of the end plate 18 quickly abut each other, generating reactive force. Thus, a collision reactive force can be quickly generated outside the battery pack 12 in the event of a collision, and when the energy absorbing member 14 or the like is disposed outside the lower case 26, for example, the reactive force can be quickly made to act on the energy absorbing member 14 to cause plastic deformation thereof. As a result, the battery pack structure according to the present embodiment can improve the energy absorption performance in the event of a collision.

Also, according to the present embodiment, the reinforcing ribs 38 connecting the bosses 31 and the projecting portions 36 are provided on the face of the end plate 18 facing the lower case 26, such that the collision load F input in the event of a collision is dispersed in a planar direction across the entire end plate 18 via the reinforcing ribs 38. As a result, the battery pack structure according to the present embodiment can quickly generate collision reactive force while suppressing input of the collision load F to the battery cell 16 side.

### Supplementary Description of Embodiment

Note that in the above-described present embodiment, the bending point 32 and the abutting face 34 formed on the module bracket 24 are formed at one place, but this is not restrictive, and bending points may be formed a plurality of places on the module bracket, or a plurality of the bending points may be provided to one abutting face.

Also, in the present embodiment, the projecting portions 36 are formed in cylindrical shapes at three places on the end plate 18, but this is not restrictive, and the projecting portions may be formed at a single place or may be formed at a plurality of places other than three, and the shape may be other than cylindrical as described above.

Additionally, in the present embodiment, the reinforcing ribs 38 are formed in a lattice shape, but this is not restrictive, and may be formed as a grid of parallelograms or as a honeycomb form.

What is claimed is:

1. A battery pack structure comprising:
a battery module, including a plurality of battery cells disposed arrayed in parallel in a predetermined direction, and an end plate disposed on an outer side in an array direction of the battery cells;
a lower case that accommodates a lower portion of the battery module; and
a module bracket that fixes the end plate to the lower case such that a gap is created between the end plate and an inner wall face of the lower case, and that also includes a bending point that bends toward an end plate side at a portion facing the end plate, and further extends from the bending point along the end plate to fashion an abutting face that faces the end plate.

2. The battery pack structure according to claim 1, wherein the end plate includes a projecting portion that protrudes toward a lower case side at a position facing the lower case.

3. The battery pack structure according to claim 2, wherein a protruding portion that protrudes toward the end plate side is provided at a position on the lower case facing the projecting portion.

4. The battery pack structure according to claim 3, wherein a reinforcing rib that connects the projecting portion to a fixing portion fixing the end plate and the lower case to each other, is provided on a face of the end plate facing the lower case.
